(19) United States
(12) Patent Application Publication
(10) Pub. No.: US 2025/0285564 A1
(43) Pub. Date: Sep. 11, 2025

(54) CHANNEL LETTERS HAVING 3-D VISUAL EFFECT

(71) Applicant: Xiaowei Jiang, Guangzhou City (CN)

(72) Inventor: Xiaowei Jiang, Guangzhou City (CN)

(21) Appl. No.: 18/595,680

(22) Filed: Mar. 5, 2024

(51) Int. Cl. G09F 19/12; G09F 9/33; G09F 13/22

(52) U.S. Cl. CPC G09F 19/125; G09F 9/33; G09F 13/22; G09F 2013/222

(57) ABSTRACT

An illuminated channel letter has a frame member in the shape of a letter, number, or design shape. The frame member has a back wall member on which a source of illumination is located. Side wall members extend from the frame member and a front member overlays the side wall members. The front member has an interior layer made of translucent material positioned beneath an exterior layer made of opaque material. The exterior layer has a plurality of cut-out openings in design shapes which extend through the exterior layer, from the top surface to the bottom surface of the layer. When the source of illumination is turned on, it provides backlighting, which emits light through the interior layer and the cut-out openings of the exterior layer, thus producing a visual 3-D lighting effect emanating from the channel letter.

### FIELD OF THE INVENTION

The present intervention relates generally to the field of lighting signage, and, more particularly, to channel letters fabricated using 3-D printing technology, providing a naked-eye visual 3-D lighting effect.

### BACKGROUND OF THE INVENTION

Channel letter lighting for commercial signage is commonly and routinely utilized in the industry. Such lighting employs a number of illuminating techniques, many of which result in varied and imaginative lighting effects through the channel letter. However, none of these lighting effects, as different as they may be, are capable of providing a naked-eye visual 3-D lighting effect which emanates directly from the channel member.

Moreover, traditional fabrication of channel letters in the signage industry involves complex, labor-intensive processes requiring multiple steps of bending, cutting, and assembling various materials, such as acrylics. Such methods are not only time-consuming, but also impose limitations on the complexity and intricacies of design, thereby restricting the creative scope and potential visual impact of the signage which is produced.

### SUMMARY OF THE INVENTION

It is the object of the present invention to provide channel lettering which results in a naked-eye visual 3-D effect when backlit illumination is provided. The lettering is fabricated using 3-D printing technology, to produce a unique layering of the front member of the channel letter.

These and other objects are accomplished by the present invention, an illuminated channel letter which comprises a frame member in the shape of a letter, number, or design shape. The frame member has a back wall member on which a source of illumination is located. Side wall members extend from the frame member and a front member overlays the side wall members. The front member has an interior layer made of translucent material positioned beneath an exterior layer made of opaque material. The exterior layer has a plurality of cut-out openings in design shapes which extend through the exterior layer, from the top surface to the bottom surface of the layer. When the source of illumination is turned on, it provides backlighting, which emits light through the interior layers and the cut-out openings of the exterior layer, thus producing a visual 3-D lighting effect emanating from the channel letter.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is a partial exploded view of the internal components of the channel letter of the present invention.

FIG. 2 is an angled view of a channel letter of the present invention, illustrating the manner in which the naked-eye visual 3-D lighting effect is accomplished.

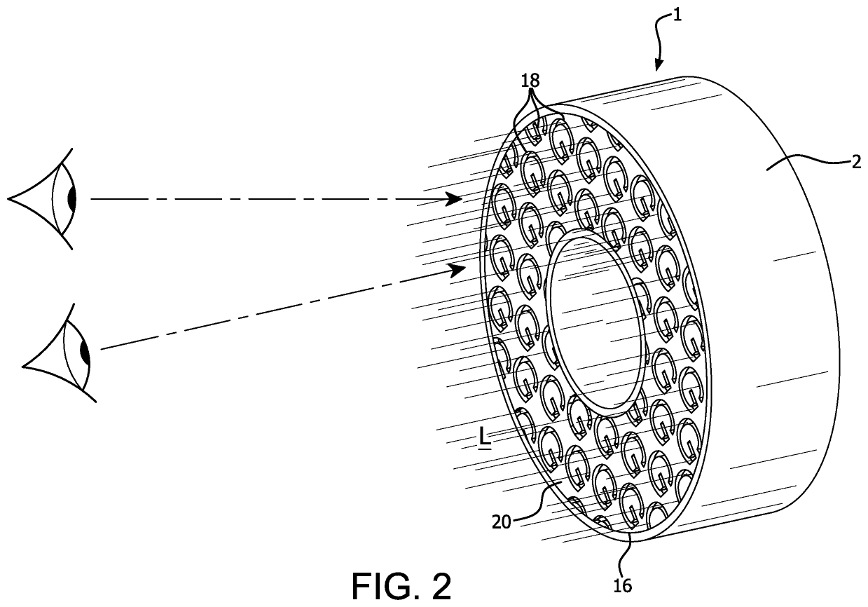

### DETAILED DESCRIPTION OF THE INVENTION

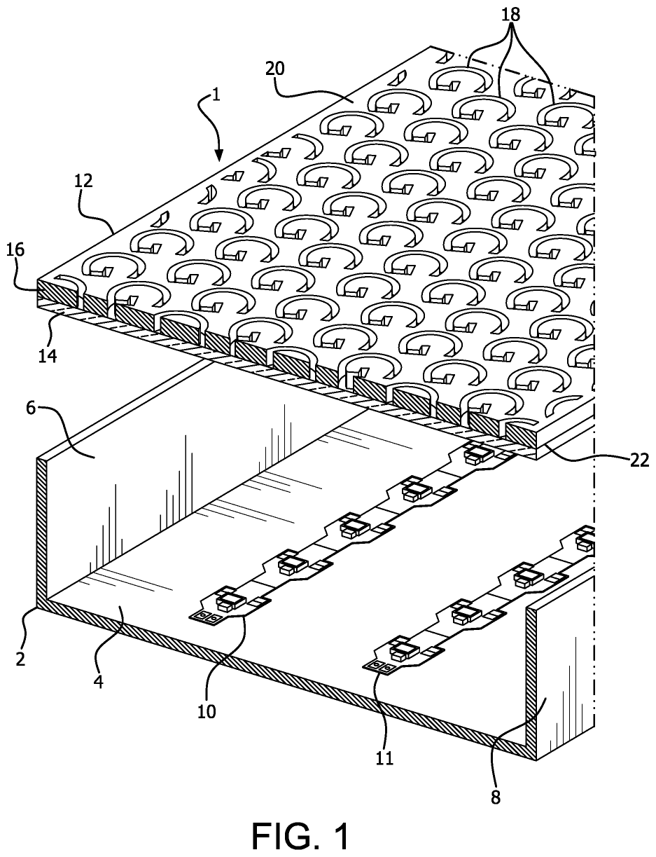

Channel letter 1 of the present invention comprises frame member 2 having bottom wall 4 and side walls 6 and 8 extending up from the bottom wall. Illumination source is shown in FIG. 1 as LED strip lighting 10 and 11. Front member 12, overlaying side walls 6 and 8, comprises interior layer 14 located beneath exterior layer 16. Interior layer 14 is fabricated of a translucent material while exterior layer 16 is fabricated of an opaque material. The layers are produced by using a 3-D printing process. Exterior layer 16 is formed with a plurality of cut-out openings 18 which extend all the way through the exterior layer, from its top surface 20 to its bottom surface 22. Cut-out openings 18 can take the shape of letters, numbers, symbols, commercial logos, or other artistic designs.

The layers are positioned so that interior layer 14 resides beneath exterior layer 16 to form front member 12.

In use, illumination source 10 and 11 is turned on resulting in channel backlighting which emits light L through layer 14 and only cut-out openings 18 of exterior layer 16 of front member 12. This produces a naked-eye visual 3-D lighting effect emanating from channel letter 1, when viewed at an angle in relation to the channel letter. Advantageously, the 3-D lighting effect varies as the angle of viewing of the channel letter 1 changes. In addition, cut-out openings with more of a curved, bent line, or angled surface enhance the 3-D lighting effect.

While the disclosure herein illustrates a channel letter configured as the letter “O,” this letter channel shape and that of its frame member are not to be considered restricted to alphabet letters. It is contemplated that channel letters having any shape, including numbers, commercial logos, or other artistic design configurations can be utilized with the present invention. Similarly, LED lighting, or any illumination source of choice, can be employed to light the channel letter.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. An illuminated channel letter comprising:
a frame member in the shape of a letter, number, or design shape, said frame member comprising a back wall member on which a source of illumination is located, side wall members extending from the frame member, and a front member overlaying the side wall members, said front member comprising an interior layer made of translucent material positioned beneath an exterior layer made of opaque material, the exterior layer having a front surface and a rear surface and a plurality of cut-out openings which extend from the front surface to the rear surface of the front member, the interior and exterior layers extending the length, width, and breadth of the channel letter, whereby when the illumination source is turned on, it provides backlighting which emits light through the interior layer, and the cut-out openings of the exterior layer, producing a visual 3-D lighting effect emanating from the channel letter.

2. The illuminated channel letter as in claim 1 wherein the cut out-openings comprise letters, numbers, or design shapes having curved, bent line, or angular surfaces which extend from the front surface to the rear surface of the front member to enhance the visual 3-D lighting effect.

3. The illuminated channel letter as in claim 1 wherein the 3-D lighted effect varies in accordance with the angle of viewing of the channel letter.
